(19) United States
(12) Patent Application Publication
(10) Pub. No.: US 2007/0184926 A1
(43) Pub. Date: Aug. 9, 2007

(54) Transmission mechanisms and components therefor

(76) Inventor: Kevin Joseph Martin, New South Wales (AU)

Correspondence Address: KING & SCHICKLI, PLLC, 247 NORTH BROADWAY, LEXINGTON, KY, 40507, US

(21) Appl. No.: 10/583,485

(22) PCT Filed: Nov. 30, 2004
(86) PCT No.: PCT/AU04/01670

§ 371 Date: Jun. 15, 2006

(30) Foreign Application Priority Data
Dec. 18, 2003 (AU) 2003907032

(51) Int. Cl. F16G 1/28

(52) U.S. Cl. 474/202

(57) ABSTRACT

A cable assembly suitable for use in a transmission mechanism which includes at least one wheel which the cable assembly passes at least partialy around when in use. The cable assembly includes at least one cable having end portions and connecting means for operatively connecting the end portions of the cable so as to form an endless track, the connecting means including a power transmission member and coupling means operatively connecting the end portions of the cable to the power transmission member, the power transmission member being receivable within recesses in the wheel as the cable assembly passes therearound.

This invention relates generally to transmission mechanisms and components therefore and more particularly to mechanisms of the type which include an endless track adapted to travel around a plurality of guide elements.

One particular application of the present invention concerns its use in conveying apparatus. One particular form of conveying apparatus is described in Australian Patent Specification No. 27682/02. The contents of Patent Specification No. 27682/02 is incorporated into the present specification by way of cross reference. It will be convenient to hereinafter describe the invention with reference to this particular application however, it is to be understood that this is not to be taken as a limitation as to the scope of the present invention.

In Australian Patent Specification No. 27682/02 there is described a mechanism in which the endless track members are in the form of chains which are adapted to cooperate with sprockets. A disadvantage of chain members is that they are relatively bulky and heavy.

According to one aspect of the present invention there is provided a cable assembly suitable for use in a transmission mechanism which includes at least one wheel which the cable assembly passes at least partially around when in use, the cable assembly including at least one cable having end portions and a connector for operatively connecting the end portions of the cable so as to form an endless track, the connector including a power transmission member and a coupling operatively connecting the end portions of the cable to the power transmission member, the power transmission member being receivable within recesses in the wheel as the cable assembly passes therearound.

In one form a plurality of wheels may be provided. Preferably, the or each wheel is in the form of a sheave which has a plurality of grooves formed in the outer peripheral surface thereof, the grooves communicating with cavities in the outer peripheral surfaces. The recesses are preferably disposed at the edges of the peripheral surface.

The cable assembly may include a plurality of cables each being associated with a respective groove and cavity in the sheave. As mentioned earlier, each cable has end portions which are operatively connected together by the connector so as to form an endless cable or track. Preferably, a plurality of connector are arranged in spaced apart relation along the cable length. Each connector may include a power transmission member which may be in the form of a tubular body or trunnion having end portions which are receivable within the recesses in the drive wheel. The end portions may include rotatable bushes. In one particular application the power transmission members are adapted to have connected thereto carriages such as those shown and described in Australian Patent Specification No. 27682/02.

The connector may further include a coupling operatively connecting the end portions of the cable to the power transmission member. In one form the coupling may include a clevis secured to the outer surface of the tubular member and a tongue on the end of the cable. The tongue may be connected to the cable by swaging or any other suitable process. A pin preferably provides for connection between the tongue and clevis.

In another form the coupling may include a plate mounted to the tubular member for at least partial rotation relative thereto. The plate includes one or more tongue portions and the coupling farther includes at least one clevis associated with a respective tongue portion the clevis being operatively connected to an end of the cable with the tongue being operatively connected to the clevis. Retaining rings may be provided on the outer surface of the tubular member to limit lateral movement of the plate.

Preferred embodiments of the invention will hereinafter be described with reference to the accompanying drawings, and in those drawings:

FIG. 1 is a schematic side elevation of a drive device according to the present invention;

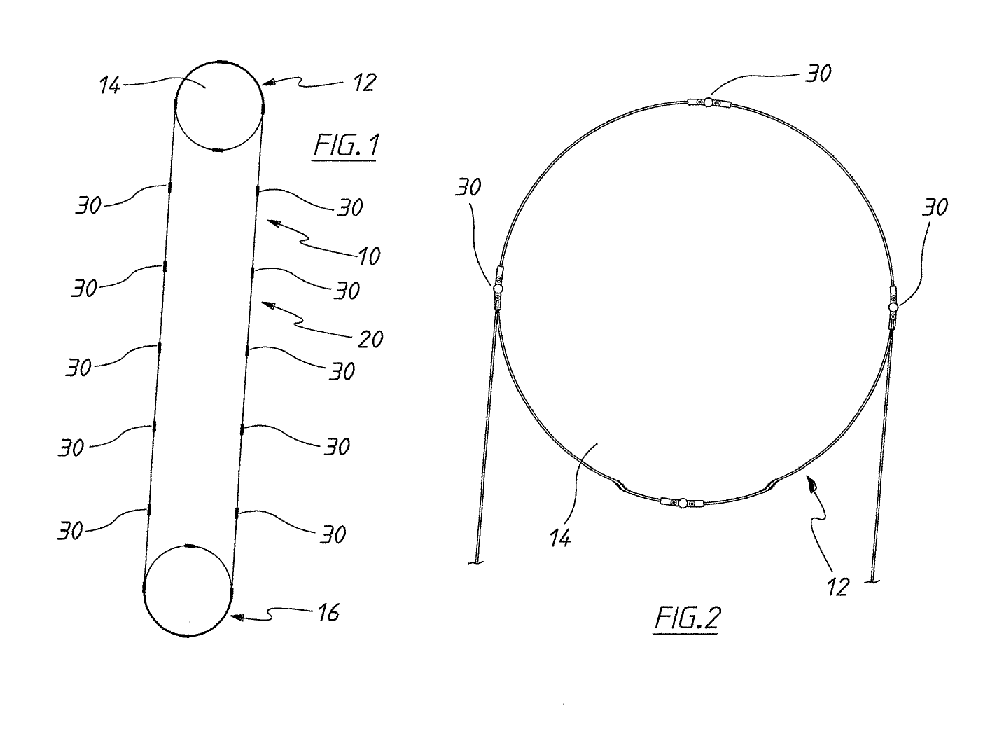

FIG. 2 is a detail of part of the drive device shown in FIG. 1; and

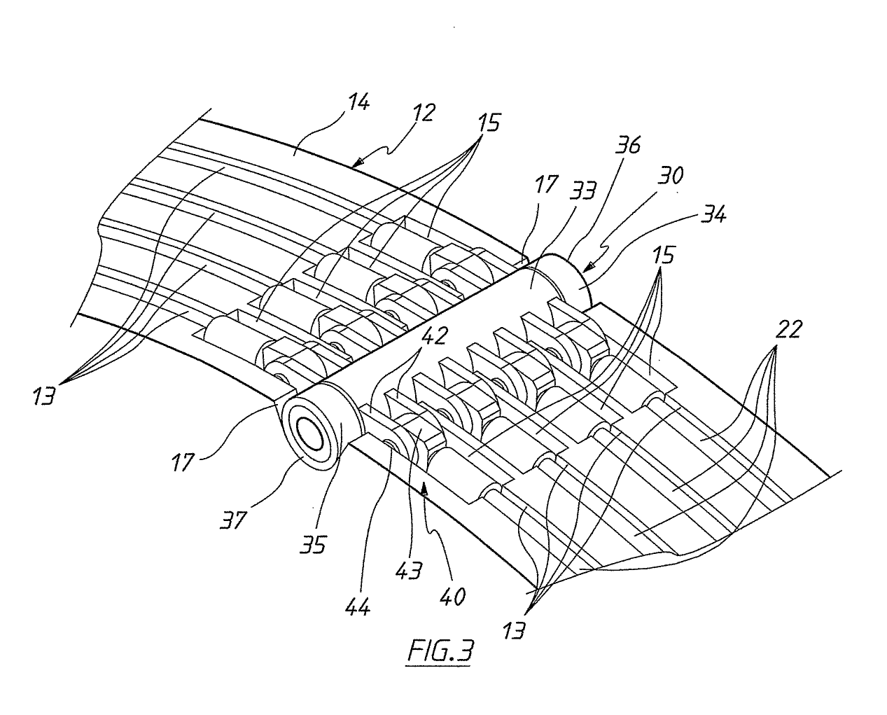

FIG. 3 is a specific detail of part of first embodiment of device in shown in FIGS. 1 and 2.

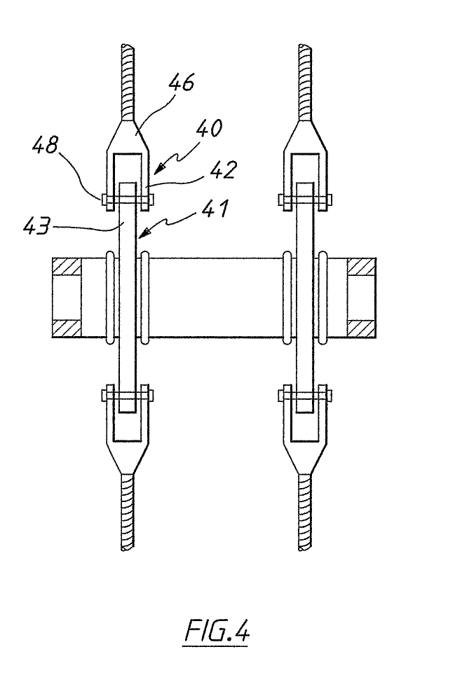

FIG. 4 is a schematic plan view of a second embodiment of device;

FIG. 5 is an end view of the device shown in Figure A; and

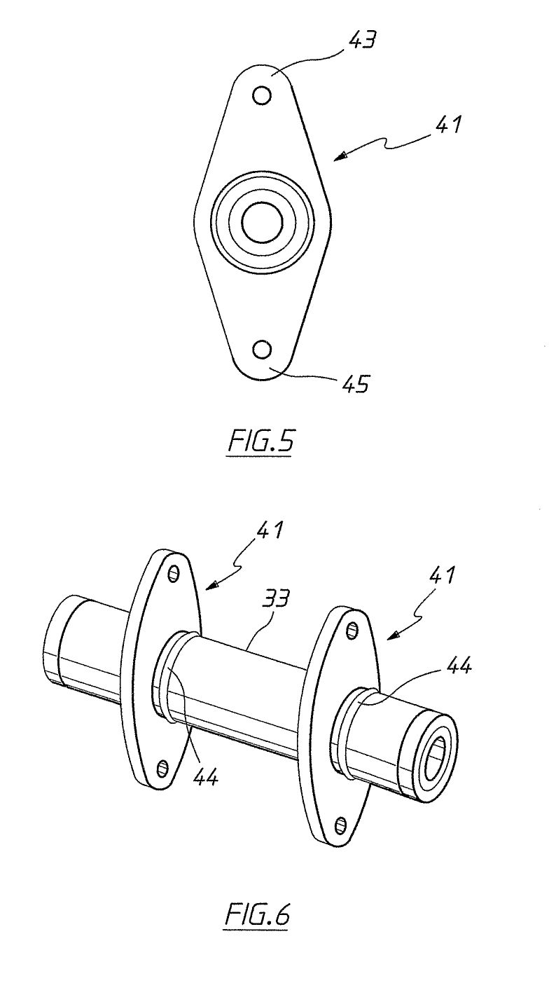

FIG. 6 is a perspective view of part of the device shown in FIGS. 4 and 5.

Referring to FIG. 1 of the drawings there is shown a transmission mechanism generally indicated at 10 comprising a first wheel 12 and a second wheel 16. In the preferred embodiment shown the wheels are in the form of sheaves 14 which have a plurality of grooves 13 formed in the outer peripheral surface thereof, the grooves communicating with cavities 15. The sheaves further include recesses 17 at the edges of the peripheral surface.

The transmission mechanism 10 further includes a cable assembly 20 which comprises a plurality of cables 22 each being associated with a respective groove and cavity in the sheave. Each cable 22 has end portions 24 and 25 which are operatively connected together by connecting means 30 so as to form an endless cable or track. As best seen in FIG. 1 a plurality of connecting means 30 are arranged in spaced apart relation along the cable length. Each connecting means 30 includes a power transmission member 32 in the form of a tubular member or trunnion 33 having end portions 34 and 35 which are receivable within the recesses 17. The end portions 34 and 35 comprise a rotatable bush 36 and 37. The power transmission members are adapted to have connected thereto carriages such as those shown and described in Australian Patent Specification No. 27682/02.

A coupling 40 operatively connects the end portions of the cable to the power transmission member. The coupling 40 as shown in FIG. 3 includes a clevis 42 secured to the outer surface of the tubular member and a tongue 43 on the end of the cable. The tongue may be connected to the cable by swaging or any other suitable process. A pin 44 provides for connection between the tongue and clevis. Provision may be made for adjustment of the connection of the cable to the power transmission member.

As shown in FIGS. 4 to 6 the coupling 40 includes coupling member 41 in the form of a plate 42 pivotally mounted on the tubular member. Lateral movement of the plate 42 is limited by retaining rings 44. The plate 42 includes tongues 43 and 45 thereon. The coupling means further includes a clevis 46 swaged to the ends of the cable. A pin 48 provides for connection between a tongue 43 and its associated clevis.

As will be appreciated any number of cables can be provided for the cable assembly. In one form the power transmission members may be segmented. If desired the sheaves may also be segmented. The distance between the power transmission members can be varied to accommodate attachments that travel around at a timed sequence.

Advantages of the system of the invention include that it is less bulky and relatively light and further alleviates problems associated with slippage and creeping.

It will be appreciated that when in the assembled position one or more power transmission members 32 are located within recesses 17 in the wheel 12. As the wheel rotates one of the transmission members disengages from the recess and a further transmission member will become engaged.

Finally, it is to be understood that various alterations, modifications and/or additions may be incorporated into the various constructions and arrangements of parts without departing from the spirit or ambit of the invention.

1. A cable assembly suitable for use in a transmission mechanism which includes at least one wheel having recesses therein which the cable assembly passes at least partially around when in use, the cable assembly including at least one cable having end portions and a connector device for operatively connecting the end portions of the cable so as to form an endless track, the connector device including a power transmission member and a coupling operatively connecting the end portions of the cable to the power transmission member, the power transmission member being a generally tubular member having end sections receivable within the recesses in the wheel as the cable assembly passes therearound, the coupling including a coupling element operatively connected to the power transmission member between the end sections.

2. A cable assembly according to claim 1 wherein the or each wheel of the transmission mechanism is in the form of a sheave which has a plurality of grooves formed in the outer peripheral surface thereof, the grooves communicating with cavities in the outer peripheral surfaces, the recesses being disposed at the edges of the peripheral surface, the cable assembly further including a plurality of cables each being associated with a respective groove and cavity in the sheave.

3. A cable assembly according to claim 1 wherein each cable has end portions which are operatively connected together by the connector device so as to form an endless cable or track, there being, a plurality of connecting means arranged in spaced apart relation along the cable length.

4. A cable assembly according to claim 3 wherein the power transmission member is generally circular in cross-section.

5. A cable assembly according to claim 4 wherein the end sections include rotatable bushes.

6. A cable assembly according to claim 1 wherein the coupling is arranged so that the load applied to the power transmission member by the cable is in the region of the central axis of the power transmission member.

7. A cable assembly according to claim 1 wherein the coupling element of the coupling includes a clevis secured to the outer surface of the power transmission member and a tongue on the ends of the cable which is operatively connected to the clevis.

8. A cable assembly according to claim 7 wherein the tongue is connected to the cable by swaging.

9. A cable assembly according to claim 8 including a pin for connection between the tongue and clevis.

10. A cable assembly according to claim 1 wherein the coupling element of the coupling includes a plate mounted to said power transmission member for at least partial rotation relative thereto, said plate including one or more tongue portions and said coupling further including at least one clevis associated with a respective tongue portion said clevis being operatively connected to an end of the cable, the tongue being operatively connected to the clevis.

11. A cable assembly according to claim 10 further including retaining rings on the outer surface of the power transmission member to limit lateral movement of the plate.

12. A cable assembly according to claim 2 wherein the coupling is arranged so that the load applied to the power transmission member by the cable is in the region of the central axis of the power transmission member.

13. A cable assembly according to claim 5 wherein the coupling is arranged so that the load applied to the power transmission member by the cable is in the region of the central axis of the power transmission member.

14. A cable assembly according to claim 2 wherein the coupling element of the coupling includes a clevis secured to the outer surface of the power transmission member and a tongue on the ends of the cable which is operatively connected to the clevis.

15. A cable assembly according to claim 14 wherein the tongue is connected to the cable by swaging.

16. A cable assembly according to claim 15 including a pin for connection between the tongue and clevis.

17. A cable assembly according to claim 5 wherein the coupling element of the coupling includes a clevis secured to the outer surface of the power transmission member and a tongue on the ends of the cable which is operatively connected to the clevis.

18. A cable assembly according to claim 2 wherein the coupling element of the coupling includes a plate mounted to said power transmission member for at least partial rotation relative thereto, said plate including one or more tongue portions and said coupling further including at least one clevis associated with a respective tongue portion said clevis being operatively connected to an end of the cable, the tongue being operatively connected to the clevis.

19. A cable assembly according to claim 5 wherein the coupling element of the coupling includes a plate mounted to said power transmission member for at least partial rotation relative thereto, said plate including one or more tongue portions and said coupling further including at least one clevis associated with a respective tongue portion said clevis being operatively connected to an end of the cable, the tongue being operatively connected to the clevis.

20. A cable assembly according to claim 6 wherein the coupling element of the coupling includes a plate mounted to said power transmission member for at least partial rotation relative thereto, said plate including one or more tongue portions and said coupling further including at least one clevis associated with a respective tongue portion said clevis being operatively connected to an end of the cable, the tongue being operatively connected to the clevis.
